(19) United States
(12) Patent Application Publication
(10) Pub. No.: US 2008/0304032 A1
(43) Pub. Date: Dec. 11, 2008

(54) MICROLITOGRAPHIC PROJECTION EXPOSURE APPARATUS AND IMMERSION LIQUID THEREFORE

(75) Inventor: Karl-Heinz Schuster, Koenigsbronn (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/190,007

(22) Filed: Aug. 12, 2008

Related U.S. Application Data
(63) Continuation of application No. 10/566,849, filed on May 9, 2006.
(60) Provisional application No. 60/568,006, filed on May 4, 2004.
(60) Provisional application No. 60/612,823, filed on Sep. 24, 2004.

(51) Int. Cl. G03B 27/42

(52) U.S. Cl. 355/53; 355/77

(57) ABSTRACT

An immersion liquid for a microlithographic projection exposure apparatus is enriched with heavy isotopes. This reduces the chemical reactivity, which leads to an extension of the lifetime of optical elements which come in contact with the immersion liquid. For example, heavy water (D₂O), deuterated sulfuric acid, (D₂SO₄) or deuterated phosphoric acid D₃P¹⁶O₄ may be used. Organic compounds such as perfluoro polyethers, which have been deuterated or enriched with heavy oxygen (¹⁸O), are furthermore suitable.

### BACKGROUND OF THE INVENTION

1. Field of the Invention

The invention relates to microlithographic projection exposure apparatuses, such as those used for the production of microstructured components. The invention relates in particular to projection exposure apparatuses which have a projection lens designed for immersed operation, and to an immersion liquid suitable therefore.

2. Description of the Prior Art

Integrated electrical circuits and other microstructured components are conventionally produced by applying a plurality of structured layers to a suitable substrate which, for example, may be a silicon wafer. In order to structure the layers, they are first covered with a photoresist which is sensitive to light of a particular wavelength range, for example light in the deep ultraviolet (DUV) spectral range. The wafer coated in this way is subsequently exposed in a projection exposure apparatus. A pattern of diffracting structures, which is arranged on a mask, is projected onto the photoresist with the aid of a projection lens. Since the imaging scale is generally less than 1, such projection lenses are also often referred to as reduction objectives.

After the photoresist has been developed, the wafer is subjected to an etching process so that the layer becomes structured according to the pattern on the mask. The remaining photoresist is then removed from the other parts of the layer. This process is repeated until all the layers have been applied to the wafer.

One of the essential aims in the development of projection exposure apparatuses used for production is to be able to lithographically define structures with smaller and smaller dimensions on the wafer. Small structures lead to high integration densities, and this generally has a favorable effect on the performance of the microstructured components produced with the aid of such systems.

The size of the structures which can be defined depends primarily on the resolution of the projection lens. Since the resolution of the projection lenses is proportional to the wavelength of the projection light, one way of decreasing the resolution is to use projection light with shorter and shorter wavelengths. The shortest wavelengths used at present are in the deep ultraviolet (DUV) spectral range, namely 193 nm and 157 nm.

Another way of decreasing the resolution is based on the idea of introducing an immersion liquid with a high refractive index into an intermediate space which remains between a last lens on the image side of the projection lens and the photoresist. Projection lenses which are designed for immersed operation, and which are therefore also referred to as immersion lenses, can achieve numerical apertures of more than 1, for example 1.3 or 1.4. The immersion, moreover, not only allows high numerical apertures and therefore improved resolution but also has a favorable effect on the depth of focus. The greater the depth of focus is, the less stringent are the requirements for exact axial positioning of the wafer in the image plane of the projection lens.

In the past, various fluorinated carbon compounds and highly pure water have predominantly been studied as immersion liquids. Although fluorinated carbon compounds often have a higher refractive index than water, the transmission for short-wave projection light is nevertheless greater with highly pure water. High purity of the water is necessary since even small amounts of impurities detrimentally reduce the transmission.

On the other hand, high purity of the water constitutes a great problem for the durability of the surfaces next to it, that is to say the last surface on the image side of the projection lens and the photosensitive layer. This is because highly pure water has a high reactivity and will start to dissolve those optical materials which are used for the production of transparent optical elements in view of their high transmission at very short wavelengths. These materials are primarily calcium fluoride, lithium fluoride and barium fluoride. Although the solubility of these crystals with respect to highly pure water is relatively low in absolute terms, even material erosion of just a few nanometers is enough to degrade the optical imaging noticeably.

Besides this, highly pure water may also chemically modify the photosensitive layer. Admittedly, it would seem quite possible to develop photosensitive layers which are not significantly affected by highly pure water. Nevertheless, it is likely that such layers would have other disadvantages such as lower photosensitivity or a less sharp exposure threshold.

### SUMMARY OF THE INVENTION

It is an object of the invention to provide an immersion liquid for a microlithographic projection exposure apparatus, which is also highly transparent for short-wave projection light but has little chemical effect on materials which come in contact with the immersion liquid.

This object is achieved by an immersion liquid which is enriched with heavy isotopes.

The invention is based on the discovery that the chemical reactivity of compounds is generally reduced when individual atoms are replaced by heavier isotopes. Chemical reactions therefore take place more slowly with compounds which are enriched with heavy isotopes. For the immersion liquid, this means that the materials coming in contact with it are affected less strongly compared with unenriched immersion liquids. The reduced chemical reactivity is attributable to the different thermal occupancy of the mass-dependent energy levels, that is to say quantum effects. The differences in the reaction rates are therefore temperature-dependent.

The term “isotopes” refers to atoms with the same atomic number, belonging to a given element, which contain different numbers of neutrons and therefore have different masses. With all elements for which there are isotopes, there is a natural isotope distribution that indicates which isotopes occur with which frequency in nature. For example, 99.762% of naturally occurring oxygen consists of the isotope ¹⁶O, 0.038% of the isotope ¹⁷O and 0.20% of the isotope ¹⁸O. This isotope distribution is also encountered in oxygen compounds. In the present case, a liquid will generally be referred to as enriched with heavy isotopes if, starting with the natural isotope distribution, a single atom has been replaced by a heavier isotope. With reference to the example of oxygen, for instance, this could mean that the natural isotope distribution has been shifted by 1 per thousand from the isotope ¹⁶O in favor of the heavier isotope ¹⁷O, that is to say the compounds contain only 99.662% instead of 99.762% of the isotope ¹⁶O, whereas they contain 0.138% (rather than 0.038%) of the isotope ¹⁷O.

In order for the reduced reactivity to be noticeable at all, the proportion of at least one heavy isotope should be at least doubled, and preferably at least one hundred times greater, in comparison with the natural isotope distribution.

The relative mass change between different isotopes is comparatively small for heavier elements, which in this context also include oxygen. In heavier elements, therefore, the isotopes differ only little with respect to their chemical properties and therefore with respect to their reactivity. Enrichment of immersion liquids with the isotopes of heavier elements, such as oxygen, therefore leads to only a comparatively small reduction in the reactivity.

Isotopes of elements with a low atomic number, however, may differ greatly with respect to their chemical properties. These differences are particularly significant for hydrogen, which contains only one proton. There are three isotopes of hydrogen, namely the light hydrogen ¹H also referred to as protium, the heavy hydrogen ²H usually referred to as deuterium D, which contains one proton and one neutron, and superheavy hydrogen ³H, which contains one proton and two neutrons and is also referred to as tritium T. Since the masses of the three hydrogen isotopes are in the proportion 1:2:3, the percentage mass difference between the isotopes is large.

The natural isotope distribution of hydrogen is 99.9855% for light hydrogen, 0.0145% for deuterium and 10⁻¹⁵% for tritium. If all the molecules in a liquid contain hydrogen, and if more than 2% of these molecules in turn contain deuterium, then this corresponds to enrichment by more than 100 times in comparison with the natural isotope distribution.

Yet the higher reaction inertia of deuterium is not yet very noticeable even with such enrichment, since the chemical properties are still dominated by the 98% of the molecules which contain not deuterium but light hydrogen. Preferably more than 80% and, more preferably, more than 99% of the molecules contained in the immersion liquid should therefore contain deuterium instead of hydrogen.

The relatively low reactivity of deuterium compounds in comparison with compounds that contain light hydrogen becomes noticeable primarily when the hydrogen content in the immersion liquid is relatively high overall. This applies to water, for example, since two hydrogen atoms occur on each oxygen atom. Water which is deuterated to a high degree is generally referred to as heavy water (D₂O) and is produced on an industrial scale. If virtually all of an immersion liquid consists of heavy water (that is to say more than 99 molar percent) then it will have a significantly reduced reactivity in comparison with normal water, that is to say water with a natural isotope distribution. The lifetime of sensitive optical materials, for example calcium fluoride crystals, can thereby be extended by a factor of about 5 or more. This presents significant cost advantages, since such optical materials are very expensive. Furthermore, replacement of the optical elements in question leads to prolonged down-times of the projection exposure apparatuses and therefore to production losses.

Besides D₂0, heavy water may also contain substantial amounts of DHO which likewise has a reduced reactivity in comparison with normal water (H₂0). An extra reduction in the reactivity can be achieved if at least some of the oxygen is also replaced by the heavier oxygen isotope ¹⁸O.

If heavy water is used as the immersion liquid, then the projection exposure apparatus may contain a thermal regulating device by which the immersion liquid can be brought to a setpoint temperature, which is at least approximately equal to the temperature at which heavy water has its maximum refractive index for a given ambient pressure. The refractive index of liquids generally depends on their temperature and the wavelength of the light passing through the liquid. Minor temperature fluctuations, as may occur owing to the energetic projection light as it passes through the immersion liquid or owing to coldness of evaporation, cause local refractive index fluctuations via this dependency. These in turn lead to striation of the immersion liquid and therefore possibly to serious impairment of the imaging quality of the projection lens.

But if the immersion liquid is kept to a temperature at which heavy water has its maximum refractive index, then temperature fluctuations will only lead to very small differences in the optical path length. It is advantageous to use heavy water in this context because heavy water reaches its maximum refractive index at a relatively high temperature, which is about 11.28° C. at an ambient pressure of 1 bar and a wavelength of λ=589 nm. Conversely, this temperature is about −0.4° C. for normal water under the said conditions, and therefore below the freezing point.

In view of the temperature dependency, moreover, it is advantageous to use heavy water as the immersion liquid even if the setpoint temperature adjusted by the thermal regulating device lies significantly above the temperature interval, between about 10° C. and 13° C., containing the temperature at which the maximum refractive index is reached for the conventionally used wavelengths and the normally prevailing ambient pressures. If the immersion liquid is at the temperature of 22° C. normally prevailing in most microlithographic projection exposure apparatuses, for example, then the temperature dependency will be reduced by about a factor of 2 in comparison with light water; the exact value of the factor depends inter alia on the wavelength of the projection light.

The reduced temperature dependency of the refractive index of heavy water makes it possible to significantly increase the thickness of the immersion layer, but without the stronger heating leading to a significant impairment of the imaging properties. The minimum distance between the last optical surface on the image side and a photosensitive layer to be exposed, which hitherto has usually been 2 mm, may now be more than 2.5 mm, for example, or even more than 5 mm.

Owing to the reduced temperature dependency of the refractive index, furthermore, the projection lens can be designed so that the immersion liquid is convexly curved towards an object plane of the projection lens during immersed operation. This can be achieved, for example, if the immersion liquid is directly adjacent to a concavely curved surface on the image side of the last optical element on the image side during immersed operation. This provides a kind of “liquid lens”, the advantage of which is primarily that it is very cost-effective. A calcium fluoride crystal, which is very expensive, has hitherto mainly been used as a material for the last imaging optical element on the image side in projection exposure apparatuses which are designed for wavelengths of 193 nm. The calcium fluoride crystal becomes gradually degraded owing to the high radiation intensities which occur in this last imaging optical element on the image side, which in the end makes it necessary to change it.

If this crystal is “replaced” by heavy water, a fact which must of course be taken into account when configuring the projection lens, then this leads to a substantially more cost-effective solution. Although the optical paths of the projection light in such a heavy-water “liquid lens” are comparatively long, and more heat is therefore produced owing to absorption, the refractive index remains relatively constant owing to the low temperature dependency of heavy water.

A protective plate which seals the liquid lens at the bottom, and which may for example consist of LiF, may also be arranged between such a liquid lens and a photosensitive layer to be exposed.

The immersion liquid may contain both light and heavy water, or it may consist of only one of these two components. Even with a mixing ratio of 1:1, the immersion liquid has a significantly reduced reactivity in comparison with highly pure normal water.

Another compound with a high hydrogen content which is suitable as an immersion liquid is sulfuric acid H₂SO₄. Deuterated sulfuric acid D₂SO₄ is substantially more chemically inert than normal sulfuric acid H₂SO₄, and it also has the advantage of a refractive index which is about 30% higher in comparison with water. A further reduction in the reactivity can be achieved if the heavier isotope ¹⁷O, or in particular ¹⁸O, is used instead of the oxygen isotope ¹⁶O. In the latter case, the immersion liquid contains significant amounts of D₂S¹⁸O₄.

An even smaller chemical reactivity and a higher refractive index may be achieved if the immersion liquid contains deuterated phosphoric acid D₃P¹⁶O₄. For example, a 15% deuterated phosphoric acid solution has a refractive index of 1.65. A further reduction in the reactivity can be achieved if the heavier isotope ¹⁷O, or in particular ¹⁸O, is used instead of the oxygen isotope ¹⁶O, yielding D₃P¹⁷O₄ or D₃P¹⁸O₄. Of course, the solution may contain heavy water a well. The smallest chemical reactivity is thus achieved with an aqueous solution of D₃P¹⁸O₄.D₂O although even the less enriched D₃P¹⁶O₄.H₂O has still a very low chemical reactivity.

Enrichment with heavier isotopes is also possible for organic immersion liquids, where it likewise leads to a reduced reactivity. Organic immersion liquids which are particularly suitable for being enriched with the oxygen isotope ¹⁸O are described in US 2002/0163629 A1, the content of which is fully incorporated into the subject-matter of the present application. These are various perfluoro polyethers (PFPE) which are available under the brand names Fomblin Y®, Fomblin Z® and Demnum™. The perfluoro polyethers enriched with the heavy oxygen isotope ¹⁸O can be described by the following chemical formulae:

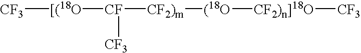

with m+n=8 to 45 and m/n 20 to 1000;

CF₃—[(¹⁸O—CF₂—CF₂)ₘ—(¹⁸O—CF₂)ₙ]¹⁸O—CF₃
with m+n=40 to 180 and m/n 0.5 to 2
and

F₂[(CF₂)₃—¹⁸O]ₙ]—CF₂—CF₃.

Examples of other organic immersion liquids which have high refractive indices and reduced chemical reactivity when deuterated and/or enriched with the oxygen isotope ¹⁸O and which are therefore suitable as immersion liquids, are the heavy perfluoro polyethers listed below:

DO—CD₂-CF₂O—(CF₂CF₂O)ₘ—CF₂—CD₂OD;

D¹⁸O—CD₂-CF₂¹⁸O—(CF₂CF₂¹⁸O)ₘ—CF₂—CD₂¹⁸OD;

DF₂CO—(CF₂CF₂O)ₘ—(CF₂O)ₙCF₂D;

DF₂C¹⁸O—(CF₂CF₂¹⁸O)ₘ—(CF₂¹⁸O)ₙCF₂D.

CF₃(¹⁸OCF₂CF₂)ₘ—(¹⁸OCF₂)ₙ—¹⁸OCF₃, and long-chained hydrocarbons in which at least 10% of the hydrogen is replaced by deuterium, have similar properties.

An organic immersion liquid should contain at least 1 molar percent, but preferably more than 10 molar percent and in particular more than 90 molar percent of at least one of the organic compounds mentioned above by way of example.

An additional or alternative way of resolving the problem of chemically corrosive immersion liquids is to provide a projection lens in which the refractive index of the last surface on the image side is at least approximately the same as the refractive index of the immersion liquid. Although this measure does not prevent the immersion liquid from chemically attacking a last surface on the image side of the projection lens, it does reduce the detrimental consequences for the imaging quality. This is because of the closer the ratio of the refractive indices of this surface and of the immersion liquid lies to 1, the less is the refraction at the interface. If the refractive indices were exactly the same, then light would not be refracted at the interface and therefore the shape of the interface would actually have no effect on the beam path. Local deformations on the surface, due to the immersion liquid, could not then affect the imaging quality.

No material pairings of solid and liquid substances are yet known which are suitable respectively as a lens material and as an immersion liquid, and which have exactly the same refractive index. There are, however, material pairings in which the refractive indices of the immersion liquid and of the solid material next to it are so close to each other that the ratio of the two refractive indices differs from 1 by no more than 5%, or even by no more than 1%.

For example, if a thin layer of MgF₂ is vapour-deposited on a last surface on the image side and light water, heavy water or a mixture of the two liquids is used as the immersion liquid, then with particularly compact MgF₂ the said value may readily be less than 1%. Applying a layer by vapour deposition on the last surface on the image side has, inter alia, the advantage that arbitrarily curved layers can be produced very easily in this way.

The last optical element on the image side may moreover consist entirely of a suitable material. An example of a suitable material for this element, which may for example be a planoconvex lens or a plane-parallel plate, is lithium fluoride (LiF). At a wavelength of 193 nm, LiF has a refractive index of 1.4432 whereas the refractive index of light water (H₂O) is 1.4366 and the refractive index of heavy water (D₂O) is 1.4318. Here again, the ratio of the two refractive indices differs from 1 by less than 1% with all mixing ratios.

Another alternative or additional way of resolving the problem with the chemical reactivity of the immersion liquid is to supplement an immersion liquid, initially consisting of highly pure water, with an accurately established amount of at least one additive that is transparent for the projection light used in the projection exposure apparatus. Owing to the incorporation of additives, the water is no longer highly pure and therefore much less reactive. If additives which are also highly transparent for the projection light wavelength being used, when they are in the dissociated state, are added in a controlled way then it is possible to achieve a transparency which is only insubstantially less than that of highly pure water. Examples of additives suitable for this are LiF, NaF, CaF₂ or MgF₂. The highly pure water used as the starting-material may in this case consist of light water, heavy water or a mixture of light and heavy water.

Experiments have shown that even relatively low ion concentrations in the water are sufficient to significantly reduce its chemical reactivity. In particular, it has been found that the at least one additive should dissociate in the immersion liquid so that the electrical conductivity of the immersion liquid is between about 4×10⁻⁸ S/m and about 4×10⁻⁶ S/m, and particularly preferable between about 3.5×10⁻⁸ S/m and about 6×10⁻⁷ S/M, after adding the additive.

### BRIEF DESCRIPTION OF THE DRAWINGS

Other advantages and features of the invention will be found in the following description of the exemplary embodiments, with reference to the drawings in which:

FIG. 1 shows a meridian section through a projection exposure apparatus according to a first exemplary embodiment of the invention, in a highly simplified schematic representation which is not true to scale;

FIG. 2 shows an enlarged detail of the end on the image side of a projection lens, which is part of the projection exposure apparatus as shown in FIG. 1;

FIG. 3 shows a representation corresponding to FIG. 2, according to a second exemplary embodiment in which a layer of MgF₂ is vapour-deposited on a last lens on the image side of the projection lens;

FIG. 4 shows a detail on the image side of the projection exposure apparatus as shown in FIG. 1, according to a third exemplary embodiment in which a thermal regulating device is provided for adjusting the temperature of the immersion liquid;

FIG. 5 shows a graph plotting the temperature dependency of the refractive indices of light and heavy water and mixtures thereof;

FIG. 6 shows an enlarged detail of the end on the image side of another projection lens, in which the last optical element on the image side is a deuterated sulfuric-acid liquid lens;

FIG. 7 shows the projection lens of FIG. 6, in which the liquid lens is sealed by a plate on the image side.

### DESCRIPTION OF PREFERRED EMBODIMENTS

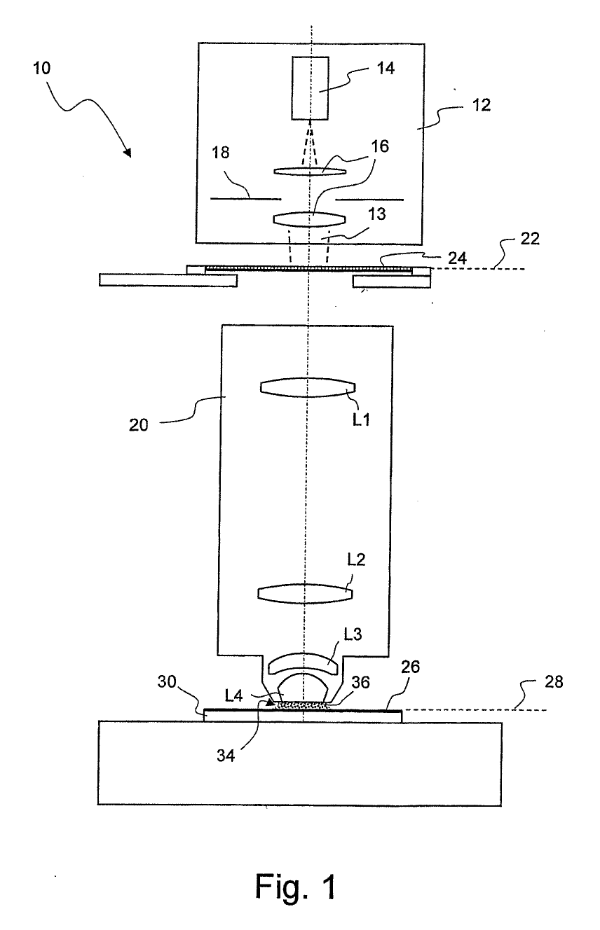

FIG. 1 shows a meridian section through a microlithographic projection exposure apparatus, denoted overall by 10, according to a first exemplary embodiment of the invention in a highly simplified schematic representation. The projection exposure apparatus 10 has an illumination device 12 for the generation of projection light 13, which inter alia comprises a light source 14, illumination optics indicated by 16 and a diaphragm 18. In the exemplary embodiment which is represented, the projection light has a wavelength of 193 nm.

The projection exposure apparatus 10 furthermore includes a projection lens 20 which contains a multiplicity of lens elements, only some of which denoted by L1 to L4 are represented by way of example in FIG. 1 for the sake of clarity. The projection lens 20 is used to project a reduced image of a reticle 24, which is arranged in an object plane 22 of the projection lens 20, onto a photosensitive layer 26 which is arranged in an image plane 28 of the projection lens 20 and is applied to a support 30. The photosensitive layer may, for example, be a photoresist which becomes chemically modified when it is exposed to projection light with a particular intensity.

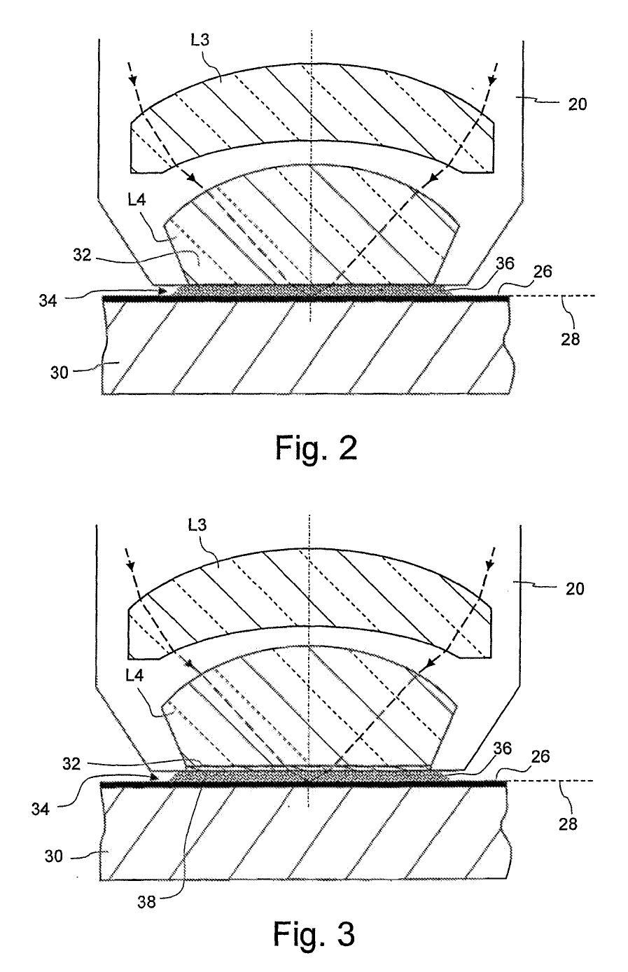

In the exemplary embodiment which is represented, the last lens element L4 on the image side is a high-aperture, comparatively thick convexoplane lens element which is made of a calcium fluoride crystal. The term “lens element”, however, is in this case also intended to include a plane-parallel plate. As can be seen particularly clearly from the enlarged representation in FIG. 2, a plane surface 32 on the image side of the lens element L4 together with the photosensitive layer 26 lying opposite delimits an intermediate space 34 in a vertical direction, which is filled with an immersion liquid 36. With an appropriate layout of the projection lens 20, the immersion liquid 36 makes it possible to increase its numerical aperture in comparison with a dry objective and/or improve the depth of focus. Since immersion objectives for microlithography projection exposure apparatuses to this extent are known, further details will not be explained in this regard.

In the exemplary embodiment which is represented, the immersion liquid 36 consists of highly pure heavy water (D₂O). The purity of the heavy water is more than 99 molar percent. This means that out of 100 water molecules, at most 1 molecule is not a D₂O molecule. The remaining molecules are either H₂O molecules or HDO molecules. The proportion of molecules other than those mentioned should be as low as possible, and should optimally not exceed 0.1 molar percent.

The heavy water used as the immersion liquid 36 has the property that, while having a similarly high transparency, it exhibits a comparatively low reactivity in comparison with highly pure light water. The calcium fluoride crystal forming the adjacent lens element L4 is therefore affected substantially less by the immersion liquid 36 than by highly pure water. Only to a minor extent, therefore, will the individual crystal layers be dissolved and gradually lead to a deformation of the originally plane last surface 32 on the image side.

The second exemplary embodiment as shown in FIG. 3 differs from the exemplary embodiment represented in FIGS. 1 and 2, on the one hand, in that a layer 38 of magnesium fluoride (MgF₂)—represented with an exaggerated thickness in FIG. 3—is vapour-deposited on the plane surface of the last lens element L4 on the image side. Highly compact magnesium fluoride has a refractive index of merely 1.4345 at a wavelength of 193 nm. At a wavelength of 193 nm, the refractive index of the layer 38 is therefore significantly closer to the refractive index n_{D2O}=1.4318 of the heavy water than the refractive index n_{CaF2}=1.5014 of calcium fluoride, which forms the lens element L4. If the heavy water attacks the layer 38, then this will indeed lead to deformation of the surface of the layer 38 that comes in contact with the water. But owing to the similar refractive indices, the refractive index ratio at this interface is so, small that the surface deformations generated in the layer 38 by the immersion liquid 36 have scarcely any optical effect.

The layer 38 may also consist of another resistant material with a low refractive index. It need not necessarily be vapour-deposited, however, but may also be applied to the plane surface 32 of the layer L4 in a different way. For example, it is also conceivable to use a self-supporting thin plate of lithium fluoride (LiF) which is bonded to the plane surface 32 of the lens element L4. The refractive index of lithium fluoride is 1.4432 at a wavelength of 193 nm. In comparison with the refractive indices of light and heavy water, the refractive index of LiF is therefore about 5‰ to 8‰ higher.

The second exemplary embodiment according to FIG. 3 also differs from the first exemplary embodiment, as represented in FIGS. 1 and 2, in that small amounts of additives are also mixed with the heavy water which is used as the immersion liquid 36. In this way, the reactivity of the immersion liquid 36 is significantly reduced further. The additives are selected according to the criterion that they absorb as little as possible of the projection light being used. In this regard, examples of suitable additives are lithium fluoride (LiF), sodium fluoride (NaF), calcium fluoride (CaF₂) and magnesium fluoride (MgF₂). The dissociated ions of these substances reduce the chemical activity of the immersion liquid 36, but without significantly compromising its high transmission capacity.

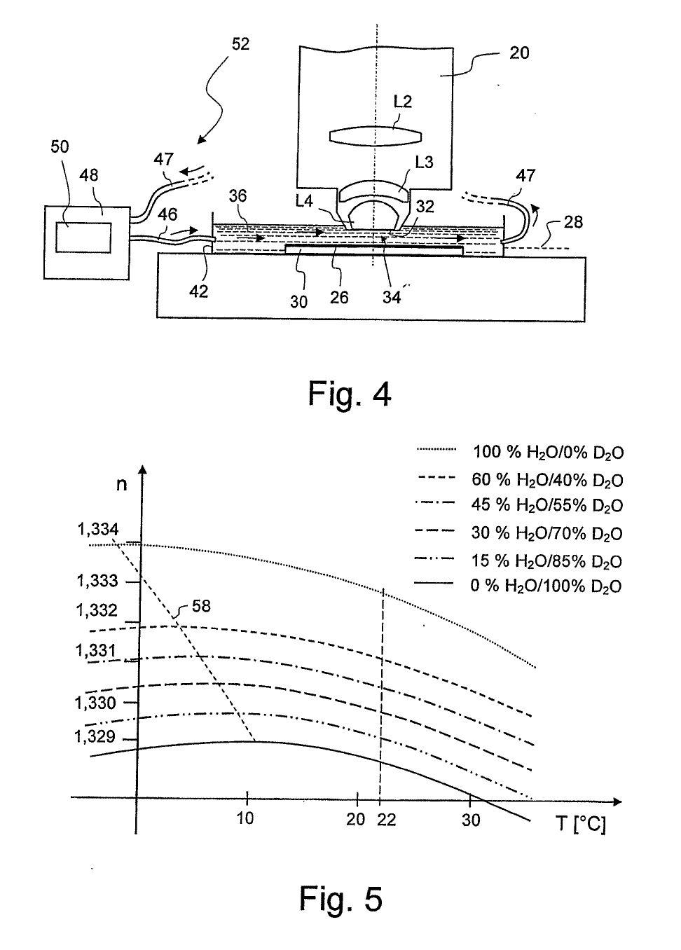

FIG. 4 shows a detail on the image side of a projection exposure apparatus according to a third exemplary embodiment. Here, the support 30 is fastened on the bottom of a container 42 which is in the shape of a trough and is open at the top. The container 42 is filled sufficiently with the immersion liquid 36 for the projection lens 20 to be immersed, with its last surface 32 on the image side in the immersion liquid, during operation of the projection exposure apparatus.

Via a feed line 46 and a discharge line 47, the container 42 is connected to a treatment unit 48 which contains a circulating pump, a filter for purifying the immersion liquid 36 and a thermal regulating device 50, in a manner which is known per se and is therefore not represented in detail. Further details may, for example, be found in U.S. Pat. No. 4,346,164 A, the disclosure of which is fully incorporated into the subject-matter of the present application. The treatment unit 48, the feed line 46, the discharge line 47 and the container 42 form an immersion device, denoted overall by 52, in which the immersion liquid 36 circulates while being purified and kept at a constant temperature.

In the exemplary embodiment shown in FIG. 4, approximately 100% of the immersion liquid 36 consists of heavy water D₂O. The thermal regulating instrument 50 is connected, in a manner which is not represented in detail, to a temperature sensor which measures the temperature of the immersion liquid 36 in the intermediate space 34. Regulation is used to ensure that the temperature in the intermediate space 34 is about 11.3° C. This corresponds approximately to the temperature at which heavy water has its maximum refractive index with an ambient pressure of 1 bar and the wavelength of 589.3 nm used in this exemplary embodiment. The temperature adjustment may be relatively imprecise here, since with this configuration the temperature fluctuations have no effect, or no significant effect, on the refractive index of the immersion liquid 36.

This will be explained below with reference to FIG. 5, which shows a graph on which the refractive index n is plotted for light water, heavy water and mixtures of light and heavy water in different mixing ratios, as a function of the temperature T. The refractive index was in this case determined for a wavelength of 589.3 nm. It can be seen from the graph that light water (H₂O) has its maximum refractive index for this wavelength and at a temperature of about −0.4° C. From there, to a first approximation, the refractive index decreases quadratically as the temperature falls or rises. The projection exposure apparatus cannot be operated at such a low temperature.

With heavy water (D₂O), however, the maximum refractive index is found at a temperature of about 11.28° C. Here again, the decrease in the refractive index towards lower or higher temperatures is likewise quadratic to a first approximation. If the thermal regulating device 50 adjusts the temperature exactly to the value at which the maximum refractive index is reached, then the temperature dependency dn/dT of the refractive index n will be equal to zero. This temperature is therefore the optimum working point for the projection exposure apparatus since minor temperature fluctuations, as may occur owing to the energetic projection light 13 or coldness of evaporation at the surface of the immersion liquid 36, do not alter the refractive index of the immersion liquid 36 and therefore the imaging properties of the projection lens 20. The immersion liquid 36 then has a constant refractive index throughout the intermediate space 34.

In mixtures of light and heavy water, the temperature at which the refractive index of the mixture in question has its maximum decreases as the proportion of water increases. This is indicated by a dashed line 58 in FIG. 5.

It is furthermore clear from FIG. 5 that even at a temperature of 22° C., which is the temperature usually set in projection exposure apparatuses, the temperature dependency of heavy water is much less than the temperature dependency of light water. In fact, with an ambient pressure of 1 bar and a temperature of 22° C., the temperature dependency of the refractive index n for light water dn/dT=96.8·10⁻⁶ 1/K, whereas for heavy water just dn/dT=41.1·10⁻⁶ 1/K, that is to say approximately half as much as for light water. Even above the optimum athermal working point of about 11° C., a significantly reduced temperature dependency of the refractive index is therefore achieved when heavy water is used. This in turn allows improved imaging and/or higher scanning rates.

Towards shorter wavelengths, the temperature dependencies dn/dT at a given temperature firstly increase, until they reach their maximum at a wavelength of about 250 nm. At even shorter wavelengths, the temperature dependency of the refractive indices decreases again. At a wavelength of 193 nm, the temperature dependency dn/dT for light water at the temperature of 22° C. is about 100·10⁻⁶ 1/K, which corresponds approximately to the value at a wavelength of 589.3 nm.

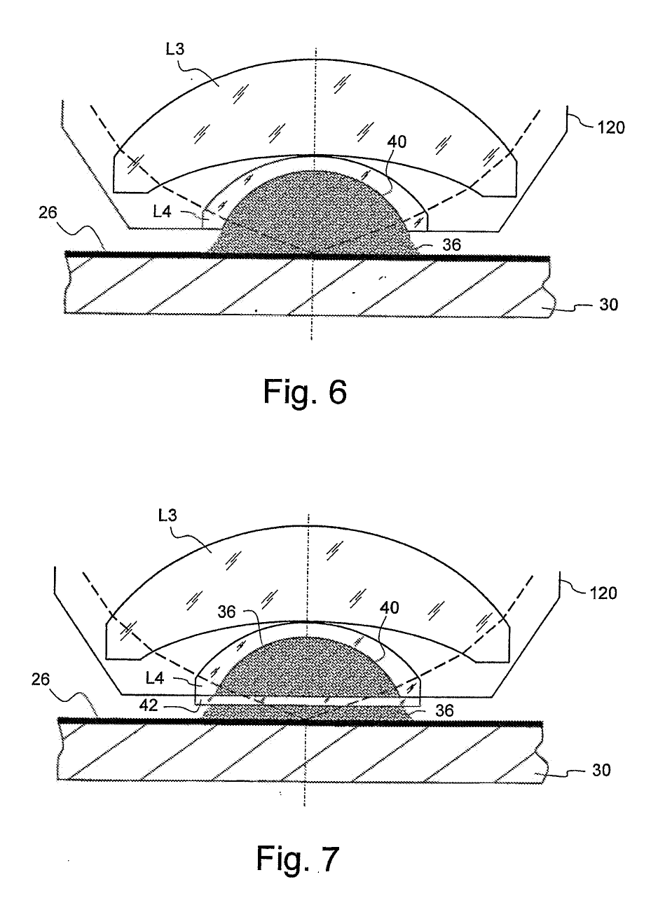

FIG. 6 shows an enlarged detail of an end on the image side of a projection lens denoted by 120, according to another exemplary embodiment in which the lens element L4 is designed as a convexoconcave meniscus lens. The immersion liquid 34, approximately 100% of which consists of deuterated sulfuric acid D₂SO₄ in this case, extends up to the concave surface 40 of the lens element L4 and is itself therefore convexly curved on the object side. The resulting “liquid lens” has the advantage, inter alia, that it can withstand heavy radiation loads particularly well in the vicinity of the end on the image side and, furthermore, it can be changed in a comparatively straightforward and cost-effective way. In this context, it should also be noted that the surrounding atmosphere ought to be as free of water as possible, since highly pure sulfuric acid is strongly hygroscopic even when it is deuterated.

An even smaller chemical reactivity and higher refractive indices may be achieved if the immersion liquid 34 contains deuterated phosphoric acid D₃P¹⁶O₄ that may be further enriched with heavy isotopes, thus yielding D₃P¹⁷O₄ or D₃P¹⁸O₄.

In order to obtain D₃P¹⁶O₄ or D₃P¹⁸O₄, the following method may be used: Highly pure phosphor is oxidized with oxygen ¹⁶O or ¹⁸O which results in P₂¹⁶O₅ or P₂¹⁸O₅, respectively. When adding heavy water D₂O, an aqueous solution is obtained whose acidity may controlled by volatilizing or by adding more heavy water. The refractive index of the solution increases and the transmission decreases with growing acidity. This means that for higher refractive indices the thickness of the intermediate space 34 should be reduced.

The smallest chemical reactivity is achieved with an aqueous solution of D₃P¹⁸O₄.D₂O although even the less enriched D₃P¹⁶O₄.H₂O has still a very low chemical reactivity.

In order to prevent the immersion liquid 34 from being contaminated and flowing out of the cavity formed below the lens element L4, the liquid lens formed by the heavy water in the variant shown in FIG. 7 is sealed on the image side by a plane-parallel plate 42 made of LiF.

1-37. (canceled)

38. An exposure apparatus that exposes a substrate through an immersion region, comprising: an optical element that has a concave surface from which exposure light emerges; and a surface that is provided to surround an optical path of the exposure light, an interface of a liquid of the immersion region being held between the surface and an object, the object being disposed at a position where the object can be irradiated by the exposure light.

39. An exposure apparatus according to claim 38, wherein at least one of a liquid immersion condition, which is for forming the immersion region, and a surface condition is set so that the interface of the liquid is held between the object and the surface by a surface tension of the liquid.

40. An exposure apparatus according to claim 39, wherein at least one of the liquid immersion condition and the surface condition is set in accordance with an object front surface condition.

41. An exposure apparatus according to claim 40, wherein the front surface condition of the object includes a contact angle condition of the liquid at the front surface of the object.

42. An exposure apparatus according to claim 39, wherein the surface condition includes at least one of a distance condition between the object and the surface, and the contact angle condition of the liquid at the surface.

43. An exposure apparatus according to claim 39, wherein the liquid immersion condition includes a condition related to at least one of a density of the liquid and an amount of the liquid.

44. An exposure apparatus according to claim 43, wherein the condition related to the amount of the liquid includes at least one of a distance condition between the object and a position of the concave surface that is farthest from the object, and a condition related to the size of the immersion region in the radial direction.

45. An exposure apparatus according to claim 38, further comprising: an adjustment apparatus that adjusts a density of the liquid that is supplied between the concave surface and the object.

46. An exposure apparatus according to claim 38, wherein the object includes the substrate.

47. An exposure apparatus according to claim 38, wherein the surface is part of a holding member that holds the optical element.

48. An exposure apparatus according to claim 38, wherein the surface is part of the optical element.

49. An exposure apparatus according to claim 38, wherein a refractive index of the liquid with respect to the exposure light is higher than that of the optical element with respect to the exposure light.

50. An exposure apparatus according to claim 38, further comprising: a projection optical system that projects a pattern image onto the substrate; wherein, the optical element that has the concave surface is an element of a plurality of optical elements of the projection optical system that is closest to an image plane of the projection optical system.

51. An exposure method, comprising: forming an immersion region so that a space between an object and a concave surface of an optical element is filled with a liquid, an interface of the liquid being positioned between the object and a surface, the surface being provided to surround the optical path of exposure light; and exposing a substrate through the immersion region.

52. An exposure method according to claim 51, wherein at least one of a object front surface condition, a surface condition, and a liquid immersion condition, which is for forming the immersion region, is set so that the interface of the liquid is positioned between the object and the surface by a surface tension of the liquid.

53. An exposure method according to claim 51, wherein the object includes the substrate.

54. A device fabricating method, wherein an exposure method according to claim 51 is used.

55. An exposure apparatus that exposes a substrate by radiating exposure light onto the substrate, comprising: a projection optical system that projects a pattern image onto the substrate and that comprises a first optical element, the first optical element having a first surface that the exposure light impinges and a second surface from which the exposure light emerges; wherein, the first surface and the second surface are substantially concentric and are spherical surfaces; and the first optical element is an element of a plurality of optical elements of the projection optical system that is closest to an image plane of the projection optical system.

56. An exposure apparatus according to claim 55, wherein the space between the substrate and the second surface of the first optical element is filled with a liquid through which the exposure light passes.

57. An exposure apparatus according to claim 56, wherein a refractive index of the liquid with respect to the exposure light is higher than that of the first optical element with respect to the exposure light.

58. An exposure apparatus according to claim 56, wherein a numerical aperture of the projection optical system is greater than a refractive index of the first optical element with respect to the exposure light.

59. An exposure apparatus that exposes a substrate by radiating exposure light onto the substrate, comprising: an optical element that has a concave surface part from which the exposure light emerges; a lower surface that is provided to surround the concave surface part; and a side surface that is provided on the outer side of the lower surface with respect to the optical axis of the optical element and that faces the optical axis.

60. An exposure apparatus according to claim 59, wherein the concave surface part of the optical element is a curved surface that is concave in a direction away from the substrate; a liquid is filled between the concave surface part and the substrate; and the side surface is provided so that the pressure of the liquid that acts upon the concave surface part decreases in a direction that intersects the optical axis direction of the optical element.

61. An exposure apparatus according to claim 59, further comprising: a support member that supports the optical element; wherein, the lower surface is formed in the optical element or the support member.

62. An exposure method that exposes a substrate by radiating exposure light onto the substrate, comprising: radiating the exposure light to an optical element, the optical element opposing a front surface of the substrate and having a concave surface part from which the exposure light emerges; and irradiating the substrate with the exposure light in a state in which a liquid is filled between the concave surface part of the optical element and a front surface of the substrate; wherein the liquid is contacted with a lower surface, which is provided to surround the concave surface part, and a side surface, which is provided on the outer side of the lower surface with respect to the optical axis of the optical element and that faces the optical axis.
